(19) United States
(12) Patent Application Publication
(10) Pub. No.: US 2005/0100483 A1
(43) Pub. Date: May 12, 2005

(54) Specimen filter container having data storage

(75) Inventor: Patrick Guiney, Concord, MA (US)

Correspondence Address: David T. Burse;Bingham McCuthen, LLP, Three Embarcadero, Suite 1800, San Francisco, CA, 94111-4067, US

(73) Assignee: Cytyc Corporation, Boxborough, MA (US)

(21) Appl. No.: 10/712,280

(22) Filed: Nov. 12, 2003

(51) Int. Cl. B01L 11/00

(52) U.S. Cl. 422/101; 356/244

(57) ABSTRACT

Apparatus, system and method for preparing a sample of a biological specimen utilizing a filter tray having a data storage device. The data storage device stores data relating to filter compatibility, expiration, and processing steps and parameters. The storage device can be attached to or positioned within the filter tray. The storage device can also be interfaced to a sample processing system.

### FIELD OF THE INVENTION

The present invention relates to preparing biological specimen slides, and more particularly, to a specimen filter container having data storage capabilities.

### DESCRIPTION OF RELATED ART

Medical professionals and technicians often store biological specimens in a solution or preservative, and later collect samples or cells of the specimen from the solution using a filter. The collected or filtered cells are placed on a slide or other specimen carrier. A technician examines the specimen slide to detect, for example, malignant or pre-malignant cells as part of a Papanicolaou (Pap) smear test and other cancer detection tests.

In many instances, specimen samples must be prepared using particular filters that are compatible with specific specimens or tests. In order to distinguish filters and identify which filters can be used with a particular test or specimen, some known systems use a color-coding system. For example, blue filters may be used with non-gynecological (non-GYN) samples, and clear filters may be used for gynecological (GYN) samples.

In conventional systems, however, a technician is typically required to verify that a filter and a specimen have not exceeded their useful life and are compatible with each other and the required testing or processing. Further, technicians are typically required to determine testing parameters or obtain them from another source after the validity and compatibility of the specimen and filter are verified.

Conventional systems for preparing samples or slides of specimens utilizing cytological filters can thus be improved. In particular, a technician should not be required to verify that filters and specimens have not expired or surpassed their useful shelf life. Further, a technician should not be required to verify the compatibility of filters and specimens processing. Processing information and operating parameters should also be more readily available to a technician. An automated system that performs or simplifies these verifications and supplies processing information can reduce or eliminate technician tasks, make slide preparation more efficient, and reduce technician errors.

### SUMMARY OF THE INVENTION

In accordance with one embodiment, an apparatus for preparing a biological specimen sample includes a filter, a filter container and a data storage device. Data related to the filter is stored in the data storage device.

In accordance with another embodiment, a system is provided for preparing a biological specimen sample using a filter that includes a specimen filter, a filter container, a data storage device associated with the container, a processor, and a communications interface, such as a serial data, mechanical or wireless interface, coupled to the data storage device and the processor. Data related to the filter is stored in the data storage device and can be retrieved by the processor via the interface.

In accordance with still another embodiment is a method of preparing a sample of a biological specimen stored in a vial using a specimen filter. The method includes associating a data storage device with a container that holds the filter, storing data related to the filter to the data storage device, retrieving the stored data from the data storage device, and utilizing the retrieved data in connection with preparing the sample.

In another embodiment, an apparatus for preparing a biological specimen sample includes a specimen filter and a data storage device associated with the filter. Data related to the filter is stored in the data storage device to indicate whether the filter has been utilized.

In apparatus, system and method embodiments, the filter may be a liquid-based filter, and the data storage device may be a read-only or read/write memory. The data storage device may be attached to a container surface or wall or positioned within a recess in the container, such as a generally straight or symmetrical recess or a tapered recess that can be used for alignment or orientation purposes. Additionally, data stored in the data storage device can indicate a test or combination of tests that are compatible with the filter, a specimen that is compatible with the filter, whether the filter has expired, a number of processing steps involving the filter or the specimen, and one or more parameters of processing steps involving the filter or the specimen.

### BRIEF DESCRIPTION OF THE DRAWINGS

Referring now to the drawings, in which like reference numbers represent corresponding parts throughout, and in which:

FIG. 1A illustrates an exemplary filter; and FIG. 1B illustrates an apparatus that includes a filter container having a data storage device;

FIGS. 2A-B are front and top views of a filter tray having a data storage device positioned within a tapered recess of the filter tray according to an alternative embodiment;

FIG. 3 illustrates a system according to the present invention that includes a specimen slide processor and a filter container with a data storage device;

FIG. 4 is a flow diagram illustrating retrieval of data from a data storage device of a filter container; and

FIG. 5 is a flow diagram illustrating preparation of a slide having a sample of a specimen; and

FIG. 6A illustrates a biological specimen vial, and FIG. 6B illustrates one manner of collecting cellular samples using a filter and transferring the collected samples onto a slide.

### DETAILED DESCRIPTION OF THE ILLUSTRATED EMBODIMENTS

Embodiments of an apparatus, system and method for preparing a specimen slide using a filter package or container that includes data storage capabilities will now be described. Data stored in a data storage device, such as a memory device, can be used for various validation and processing purposes. In the following description, reference is made to the accompanying drawings, which form a part hereof, and which show by way of illustration specific embodiments in which the invention may be practiced. It should be understood that other embodiments may also be utilized.

Persons of ordinary skill in the art will recognize that apparatus, system and method embodiments can be utilized to process and analyze various types of biological specimens. For example, the specimen can be a human specimen that is analyzed to identify cancerous or other medical conditions. The specimen can also be an animal specimen that is analyzed by a veterinarian. For purposes of illustration and not limitation, the embodiments are described with reference to gynecological (GYN) and non-gynecological (non-GYN) cancer-related specimens 120 of human patients. It should be appreciated that apparatus, system and method embodiments can be utilized with the collection and analysis of various other specimens.

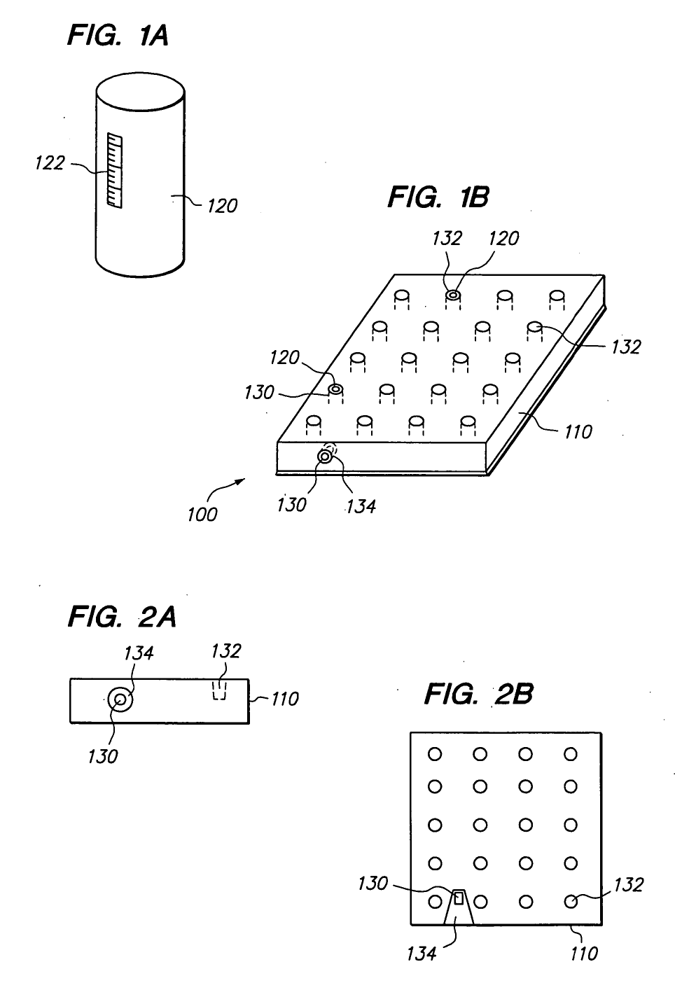

Referring to FIGS. 1A-B, an apparatus 100 includes a tray, package or container 110 (“filter tray”) for holding one or more specimen filters, such as cytological or cellular filters 120 or other suitable filters, and a data storage device 130 that is associated with the tray, e.g., attached to or embedded within the tray 110.

More specifically, the filter tray 110 includes apertures or cavities 132 in which filters 120 are stored. Exemplary filters 120 include liquid-based filters, such as Gynecological (GYN) and non-Gynecological (non-GYN) TransCyt Filters, available from Cytyc Corporation, 85 Swanson Road, Boxborough, Mass. Other suitable filters can also be utilized in addition to these exemplary filters. The filter tray can be configured to hold additional or fewer filters as needed. Thus, the filter tray can have a generally square shape (as shown), or other shapes as necessary.

The data storage device 130 can be attached to a side, top or bottom surface of the filter tray. Alternatively, a data storage device 130 can be embedded or positioned within the filter tray. For example, as shown in FIG. 1B, a data storage device 130 is positioned within a recess 134 of a filter tray 110.

In the embodiment shown in FIG. 1B, the recess 134 is a generally straight or symmetrical, cylindrical recess formed within one side of the filter tray. The recess can have different shapes to mate or interface with other processing components.

For example, in an alternative embodiment, shown in FIGS. 2A-B, a tapered recess 134 becomes narrower within the tray interior. In other words, the width and/or the height of the recess becomes narrower to form a tapered shape. A tapered recess can facilitate insertion of a filter tray within a slide processing machine. Specifically, the tapered shape may assist in aligning the filter tray when it is inserted into a processing machine. Other recess shapes, including “self-aligning” shapes can also be utilized.

The recess 134 and data storage device 130 can also be positioned in different sections of the filter tray 110 depending on how a filter tray and a processing system interface with each other. Further, one or more additional recesses and data storage devices can be utilized so that a single tray can include single or multiple data storage devices, for example, to provide additional data storage capabilities.

The apparatus 100 supports biological specimen and slide processing and preparation techniques, which reduce user or technician workload and errors. Samples of biological specimens can be prepared more accurately and efficiently. For example, a processing system can interface with the data storage device and retrieve stored data to determine whether a filter or lot of filters has expired and should not be used, which tests and samples are compatible with the filter, and parameters of processing steps.

A data storage device 130 associated with a filter tray 110 can store various types of data related to a filter or processing steps. For example, data relating to a code or identifier of a lot or group of filters, tests or combinations of tests that are compatible with a filter, specimens that are compatible with a filter, a number of steps to prepare a sample slide, operating parameters of steps involved in preparing a slide, a registration number, data integrity of, and encryption or security can be stored in a data storage device. Different amounts and allocations of memory may be used for different processing and applications. For example, in one embodiment, a data storage device can store about 529 bytes of data related to the above categories. An exemplary allocation of 529 bytes of memory follows.

Twelve bytes of memory can be allocated to a code or identifier of a lot or group of filters. A lot is generally a group of filters that have the same shelf life or expiration. For example, a lot of filters may be manufactured at the same time and have the same expiration date. In one embodiment, a filter lot code includes up to 24 digits and indicates whether a lot of filters can be used or whether the lot is expired and should be discarded.

Ten bytes of memory can indicate filter compatibility. For example, the data may indicate whether a filter is compatible with a particular test and whether a filter is compatible with a particular specimen. For example, in one embodiment, the data can identify combinations of about 80 types of filters and specimen types, including GYN specimens and non-GYN specimens, such as superficial, fluids and Fine Needle Aspirates (FNA), mucoid and other non-gynecological specimens. Indeed, different numbers of combinations can be utilized with different processing and components. Thus, the filter compatibility data is flexible and adaptable to different filter/specimen and filter/test combinations.

One or two bytes of memory indicate a number of processing steps (e.g., up to 32 steps) that are used to process a sample slide for a particular test.

Four hundred eighty bytes of memory can specify operating parameters for the processing steps, e.g., operating parameters for each of the 32 processing steps in this example. Specifically, 15 bytes of memory can specify parameters such as time, pressure, level, distance, temperature, voltage, current, etc. for each step.

Eight bytes of memory can be allocated to a registration number, such as a Read Only Memory (ROM) registration number. Some memory devices provide a unique registration number (e.g., 64 bits) that identify an individual ROM. Thus, individual ROMs and the trays of filters associated with those ROMs can be traced and accurately identified.

Sixteen bytes of memory can be allocated to encryption or security codes to ensure that only authorized users are permitted access and/or alter the stored data. For example, an authorized person having an encryption key can decrypt or decode the encrypted data.

Persons of ordinary skill in the art will appreciate that different types, configurations, sizes and allocations of data storage devices can be utilized with various embodiments. One exemplary data storage device is a DS1985 iButton memory device, available from Dallas Semiconductor, Corporation, 4401 South Beltwood Parkway, Dallas, Tex. This memory device can store 2k bytes of data, which is more than sufficient to store the 529 bytes of data described in the previous example. Thus, the exemplary device has excess memory to store other types of data as needed, for example, data relating to additional filters, tests, specimens, processing parameters, etc. Other exemplary data storage devices may include, for example, an 8-pin SOIC, TSOC, and TO-92 memory packages.

The exemplary iButton memory device is advantageous for use with certain embodiments, since it uses a unique registration number. The unique number can be used to accurately track the ROM memory device. The iButton memory device is also advantageous due to its memory capabilities, relatively small size, and interface connections to stored data, power and programming signals. via a single connection. As shown in FIG. 1A, a filter stored in a filter tray may also be marked with a bar-code, such as a 1-dimensional or 2-dimensional barcode., or another identifier or code, that contains some of the previously described information about the filter, e.g., the filter lot code.

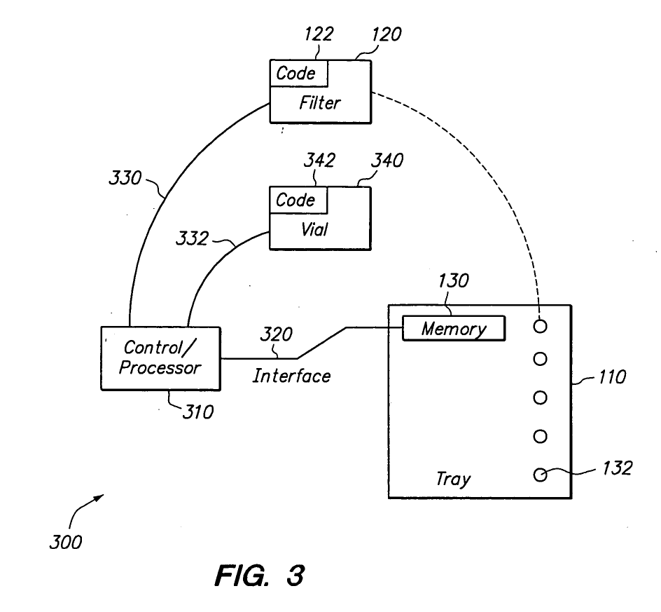

Referring to FIG. 3, a system 300 includes a slide or specimen processor 310 (“processor”), an interface or connection 320 between the processor 310 and a data storage device or memory 130 in a filter tray 110, and interfaces 330 and 332, e.g., electro-optical interfaces, coupled to the data storage device and the processor. The interfaces can read bar-codes or identifiers 122 and 342 on the filter and a vial 120 and 340, respectively.

Depending on the configuration of the processor 310 and filter tray 110, the tray 110 may be inserted into the processor 310 or be separate from the processor 310 and connected via an interface cable or other connector. For example, in one embodiment, the processor 310 is a ThinPrep 3000 slide processor, available from Cytyc Corporation. The ThinPrep 3000 processor is a batch processing system that is capable of processing multiple slides/filters simultaneously. In this system, the filter tray 110 is inserted into a housing of the processing system 310. Multiple filters can be used to simultaneously prepare multiple specimen samples.

In order to ensure that the tray is properly positioned within the processor housing, the tray can be configured with a particular shape so that the tray can be inserted into the housing in one correct orientation. Further, the recess can be shaped and/or positioned so that the tray is inserted into the housing in only one correct orientation. Thus, with a square-shaped filter tray 110, as shown in FIGS. 1B and 2B, the system may be configured so that a tray is positioned within a housing of a slide processor “recess/data storage device first” in order to properly close the system. For example, latches of the processor may only fully close when the filter tray is properly positioned, thereby informing a technician that the tray is properly loaded. Alternatively, a tray can be appropriately shaped and include a recess and data storage device on multiple or all sides of the tray so that different tray positions can be utilized.

Various interfaces can be utilized to accommodate different processor and filter configurations. Exemplary interfaces include a serial data interface and a wireless interface. A serial data interface may be used in a system in which a filter tray is inserted or loaded into a processing machine, such as the ThinPrep 3000. Other processors may utilize the same or different interfaces. For example, with the ThinPrep 2000 processor, also available from Cytyc Corporation, the filter tray is separate from the processing system, and the specimen and filter components are manually loaded. Thus, when using a processor such as the ThinPrep 2000, the interface may be a wand interface or another serial data interface connector or cable that connects the separated processor and data storage device of the filter tray. A wireless interface may also be utilized.

As a further example, the processor may have a male interface component that mates with a female/recess of the filter tray. The male and female/recess serial data interface components can also include electrodes or other connectors (e.g., one signal electrode and one reference electrode) (not shown) to connect the processing system to the data storage device in the filter tray. Thus, the data storage device is connected to the processing system when the filter tray is inserted into a processing system, such as the ThinPrep 3000. A tapered recess may be particularly useful for mating and aligning the male and female connectors and electrodes in this type of processor. Persons of ordinary skill in the art will appreciate the previously described configurations may be applicable or modified for other processing systems.

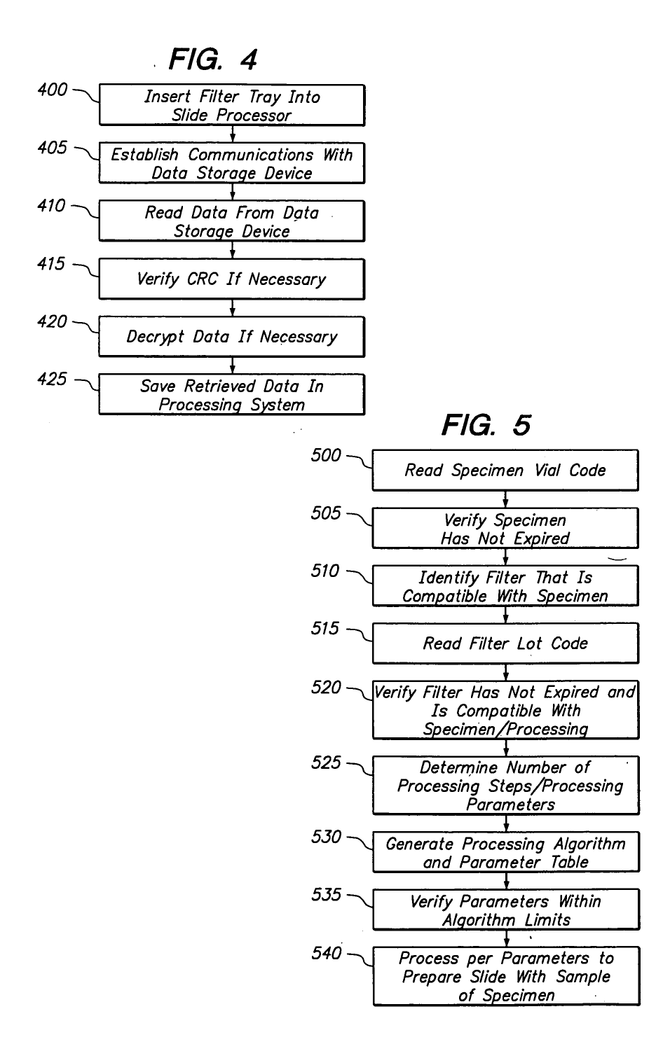

Referring to FIGS. 3 and 4, a method of preparing a sample of a biological specimen is described. Initially, in step 400, a filter tray having a data storage device is inserted into a slide processor processing. As previously discussed, different configurations of slide processors may be utilized, but for purposes of explanation, this specification refers to a slide processor in which a filter tray is inserted into the processor, such as the ThinPrep 3000. In step 405, the processor establishes communications with the data storage device of the filter tray, e.g. through electrodes or other connections to the data storage device. In step 410, the processor retrieves and reads the data stored in the data storage device. In step 415, if necessary, the processor verifies the cyclic redundancy check (CRC) to verify the integrity of the data. In step 420, if necessary, the data is decrypted or decoded. In step 425, the retrieved data may be saved in the processor and be used to prepare a slide having a sample of the biological specimen. The processor can provide an indication that data from the data storage device has been retrieved, verified and decoded with a visual or audible indication, such as an illuminated light or beep.

The data may include, for example, filter lot information including a lot code or expiration information, filter compatibility information, number of processing steps, processing step parameters, a registration number and the CRC. The. previously described steps may be performed in different orders as needed. After reading, decoding and verifying the data in the data storage device, the slide processor processes the specimen samples as shown in FIG. 5.

Referring to FIG. 5, in step 500, the processor reads the bar-code or other code or identifier on a vial holding the specimen and identifies the specimen lot code. In step 505, the processor verifies that the specimen has not expired based on the lot code. The code can also identify the type of sample, e.g. a GYN or non-GYN sample. A patient number or identifier can also be obtained from the bar-code. If the specimen has not expired, the system proceeds to step 510.

In step 510, an appropriate filter that can be utilized with the specimen is identified. Since a tray may have different types and numbers of filters, the processor may proceed to a predetermined location having the correct filter. For example, the data storage device can store a map or directory of tray locations having different filters. The processor can be programmed or configured to search for and locate the correct filter for a particular test or specimen.

In step 515, the filter lot code is obtained from the data retrieved from the filter tray's data storage device. In step 520, the processor compares the data from step 515 to the lot code printed on the filter and verifies that the filter has not expired and is compatible with the specimen type and testing or processing to be performed. In step 525, the processor determines the appropriate number of processing steps and/or parameters of the processing steps based on the retrieved data. For example, in step 530 the processing system can establish an algorithm for testing the sample type and generate a parameter table for each processing step. The parameters in the table can be derived from the ROM data.

In step 535, if necessary, the system verifies that the derived processing parameters are within the limits established by the processing algorithm. In step 540, the slide processing steps are executed using the parameters to prepare a slide having a sample of the biological specimen. Steps 500-540 are repeated as necessary for additional samples and slides to be prepared. Persons of ordinary skill in the art will recognize that it may not be necessary to perform these steps in the recited order.

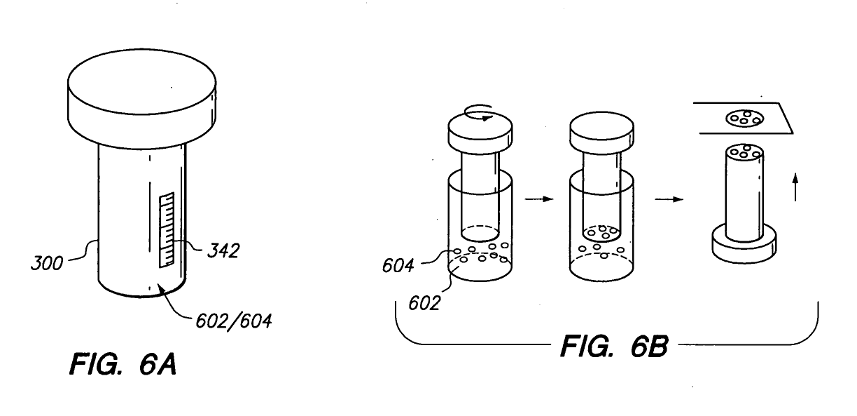

FIGS. 6A-B generally illustrate one manner of preparing a specimen slide. A vial 300 holds a suspension or solution 602, such as PreservCyt Solution available from Cytyc Corporation, that includes a biological specimen 604. The vial may be marked with a bar-code 342 or other identifier that contains information about the specimen, e.g., a specimen lot code.

In use, the vial is uncapped, and a filter is placed inside the vial. The filter may be rotated to form a homogeneous specimen and solution mixture. A vacuum (not shown) can then be applied to the filter so that specimen cells accumulate on a bottom surface of the filter. The filter can then be removed from the vial, and the filter surface with the collected cells can be applied to a slide to transfer the cells from the filter to the slide. Further details regarding the preparation of a slide in this manner are provided in U.S. Pat. No. 6,634,244, entitled Methods for Collecting Fluid Samples Having Select Concentrations of Particles, the entire contents of which are incorporated herein by reference.

Persons of ordinary skill in the art will recognize that the inventive concepts and embodiments described herein can be utilized with different types of specimens, filters, filter trays, data storage devices, slide processing systems, and analyses. For example, various types, configurations and sizes of data storage devices can be used. The data storage device can be a read-only or a read/write integrated circuit, magnetic or optical storage devices. Further, persons of ordinary skill in the art will recognize that other data can be stored to the storage device 130 depending on the particular patient, test, and analysis being performed. Further, while this specification primarily refers to ROM devices for purposes of security, data storage devices can be read/write devices and updated or supplemented if necessary.

Additionally, persons of ordinary skill in the art will recognize that embodiments of an apparatus, system and method can be applied to larger-scale processing and documentation systems. For example, a doctor who obtains specimens from patients can code a bar-code or other indicator corresponding to the patient and/or sample. A technician could then scan a filter code and retrieve data from a storage device in a filter tray and scan the code prepared by the doctor as part of the validation and compatibility verifications. Alternatively, particular coding can be reserved for particular tests so that subsequent validation and compatibility analyses can be completed with reference to a master chart or directory.

Further, persons of ordinary skill in the art will recognize that embodiments of an apparatus, system and method can be implemented by incorporating a data storage device within or on a filter instead of or in conjunction with a data storage device in the filter container. For example, a processing system can read and store a code or number of an individual filter, e.g., a barcode or serial number on or in the filter. The stored filter data can then be used to prevent the same filter from being used again.

For example, if the filter is used a second time, the processor reads the filter code, which would duplicate the same code that was previously stored when the filter was first utilized. The processor would then reject the filter since the codes match, and the slide preparation process can continue with a new or different filter that has a different code. Further, if a filter lacks a code, the filter can be rejected.

A code or number from specimen vial can also be matched or keyed to a filter. Thus, the processor can scan and store the codes of the filter and the vial. This data can be used to verify that a filter is utilized only once for a particular specimen. Thus, if the processor reads the same filter code at a later time, the filter can be rejected.

Preventing or limiting a filter from being used repeatedly can also be accomplished by counting the number of filters that are utilized within a lot of filters or only using filters that are associated with a particular code or number, such as a ROM registration number. For example, a first lot or group of filters can be uniquely identified with a ROM registration number. A processor can read the unique registration number and utilize the filters in that lot. When the first lot is exhausted of filters, the processor can be configured to reject any additional filters until a new tray of filters with a new unique ROM registration number is utilized. Thus, the processor prevents filters from the first lot being recycled. In other words, the unique ROM registration number can indicate the beginning of a group of filters that have not been previously utilized.

Accordingly, persons of ordinary skill in the art will appreciate that certain insubstantial modifications, alterations, and substitutions can be made to the described embodiments without departing from the scope of the invention, as recited in the accompanying claims.

1. Apparatus for use in preparing a biological specimen sample, comprising:
a specimen filter;
a container for holding the filter; and
a data storage device associated with the container,
wherein data related to the filter is stored in the data storage device.

2. The apparatus of claim 1, comprising a plurality of filters, the container holding the plurality of filters , and the data storage device storing data related to the plurality of filters.

3. The apparatus of claim 1, the container comprising a tray.

4. The apparatus of claim 1, the filter comprising a liquid-based filter.

5. The apparatus of claim 1, the data storage device comprising a read only memory.

6. The apparatus of claim 1, the data storage device comprising a read/write memory.

7. The apparatus of claim 1, the data storage device being attached to a surface of the container.

8. The apparatus of claim 1, the container defining a recess, the data storage device being positioned in the recess.

9. The apparatus of claim 8, the recess being generally symmetrical.

10. The apparatus of claim 8, a width or height of the recess being tapered.

11. The apparatus of claim 1, the stored data indicating a test or combination of tests that are compatible with the filter.

12. The apparatus of claim 1, the stored data indicating a specimen that is compatible with the filter.

13. The apparatus of claim 1, the stored data indicating whether the filter has expired.

14. The apparatus of claim 1, the stored data indicating a number of processing steps involving the filter or the specimen.

15. The apparatus of claim 1, the stored data indicating one or more parameters of processing steps involving the filter or the specimen.

16. The apparatus of claim 1, the stored data comprising a unique registration number of the data storage device.

17. The apparatus of claim 1, the filter comprising a cytological filter.

18. System for preparing a biological specimen sample, comprising:
a specimen filter;
a container for holding the filter;
a data storage device associated with the container;
a processor; and
a communications interface coupled to each of the data storage device and the processor, wherein
data related to the filter is stored in the data storage device and can be retrieved there from by the processor through the communications interface.

19. The system of claim 18, comprising a plurality of filters, the container holding the plurality of filters, and the data storage device storing data related to the plurality of filters.

20. The system of claim 18, the container comprising a tray.

21. The system of claim 18, the filter comprising a liquid-based filter.

22. The system of claim 18, the data storage device comprising a read only memory.

23. The system of claim 18, the data storage device comprising a read/write memory.

24. The system of claim 18, the data storage device being attached to a surface of the container.

25. The system of claim 18, the container defining a recess, the data storage device being positioned in the recess.

26. The system of claim 25, the recess being generally symmetrical.

27. The system of claim 25, a width or a height of the recess being tapered.

28. The system of claim 27, the tapered recess being configured to receive the communications interface.

29. The system of claim 18, the processor having a housing, wherein the container is positioned in the processor housing.

30. The system of claim 18, the stored data indicating a test or a combination of tests that are compatible with the filter.

31. The system of claim 18, the stored data indicating a specimen that is compatible with the filter.

32. The system of claim 18, the stored data indicating whether the filter has expired.

33. The system of claim 18, the stored data indicating a number of processing steps involving the filter or the specimen.

34. The system of claim 18, the stored data indicating one or more parameters of processing steps involving the filter or the specimen.

35. The system of claim 18, the stored data comprising a unique registration number of the data storage device.

36. The system of claim 18, the communications interface comprising a serial data interface.

37. The system of claim 18, the communications interface comprising a mechanical interface.

38. The system of claim 18, the communications interface comprising a wireless interface.

39. The system of claim 18, wherein the specimen is housed in a vial, and the vial and the filter each include a respective code.

40. The system of claim 39, further comprising a plurality of interface, respective interfaces being configured to read respective codes of the vial and the filter into the processor.

41. The system of claim 40, the respective codes comprising barcodes.

42. The system of claim 40, the respective interfaces comprising electro-optical interfaces.

43. The system of claim 18, the filter comprising a cytological filter.

44. Method of preparing a biological specimen sample, comprising:
associating a data storage device with a container that holds a filter;
storing data related to the filter to the data storage device;
retrieving the stored data from the data storage device; and
utilizing the retrieved data in connection with preparing the sample.

45. The method of claim 44, wherein utilizing further comprises determining whether the filter is compatible with a test.

46. The method of claim 44, wherein utilizing further comprises determining whether the filter is compatible with the specimen.

47. The method of claim 44, wherein utilizing further comprises determining whether the filter has expired.

48. The method of claim 44, wherein utilizing further comprises determining a number of steps involved in preparing the sample.

49. The method of claim 44, wherein utilizing further comprises determining parameters of steps involved in preparing the sample.

50. The method of claim 44, the filter comprising a cytological filter.

51. Apparatus for preparing a biological specimen sample, comprising:
a specimen filter; and
a data storage device associated with the filter,
wherein data related to the filter is stored in the data storage device to indicate whether the filter has been utilized.

52. The apparatus of claim 51, wherein a slide processor determines whether the filter was previously utilized based on the data in the data storage device.

53. The apparatus of claim 53, wherein the slide processor compares previously stored data and data stored in the data storage device of the filter.

54. The apparatus of claim 53, wherein the slide processor compares data from the filter and data from a specimen vial.

55. The apparatus of claim 53, wherein a unique number or code of the data storage device indicates a filter that has not been utilized.

56. The apparatus of claim 51, the filter comprising a cytological filter.
